(19) United States
(12) Patent Application Publication
(10) Pub. No.: US 2003/0227570 A1
(43) Pub. Date: Dec. 11, 2003

(54) Method and apparatus for processing broadcast signals and broadcast screen obtained from broadcast signals

(75) Inventors: Hee-jin Kim, Suwon-si (KR); Pil-dong Choi, Suwon-si (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/361,013

(22) Filed: Feb. 10, 2003

(30) Foreign Application Priority Data
Feb. 9, 2002 (KR) 2002-7720

(51) Int. Cl. H04N 5/445

(52) U.S. Cl. 348/564

(57) ABSTRACT

A method for processing broadcast signals, a method for displaying a broadcast screen obtained from the broadcast signals, and an apparatus therefore are provided. The method for displaying a broadcast screen obtained from broadcast signals includes displaying a PIP screen of which a main screen is formed from a first entire screen obtained from a first broadcast channel, and a sub-screen is formed from a partial screen forming a partial region of a second entire screen obtained from a second broadcast channel. A user can simultaneously see a predetermined broadcast channel and information displayed in a partial region of a corresponding screen of another broadcast channel, in improved picture quality.

### BACKGROUND OF THE INVENTION

This application claims the priority of Korean Patent Application No. 2002-7720, filed on Feb. 9, 2002, which is incorporated herein in its entirety by reference.

1. Field of the Invention

The present invention relates to a method for processing broadcast signals and displaying a broadcast screen obtained from the broadcast signals, and more particularly, to a method for processing broadcast signals using picture in picture (PIP) technology, a method for displaying a broadcast screen obtained from the broadcast signals using PIP technology, and an apparatus therefor.

2. Description of the Related Art

Picture in picture (PIP) technology makes it possible to display two broadcast signals received from two respective broadcast channels on one screen. In PIP mode, a main screen obtained by a broadcast signal received from one broadcast channel and a sub-screen that is obtained by a broadcast signal received from another broadcast channel, are displayed on one screen.

FIG. 1 is a reference view illustrating a related art method for displaying broadcast signals using a PIP technology. A first entire screen represents a broadcast screen that corresponds to a first broadcast signal, and a second entire screen represents a broadcast screen that corresponds to a second broadcast signal. The first and second “entire” screens are named as such because a broadcast screen covers the entire screen supported by a display device.

A screen taking a wider region of two screens displayed in the related art PIP mode is referred to as a main screen, and a screen taking a narrower region of the two screens is referred to as a sub-screen. If the first entire screen is selected as the main screen and the second entire screen is selected as the sub-screen, the first and second entire screens are scaled according to the size of each of the main screen and the sub-screen, and then displayed.

In the present example, the main screen has the same size as the first entire screen, and thus, the first entire screen is not reduced but displayed. However, the sub-screen is smaller than the main screen in a predetermined region inside the main screen. Thus, the second entire screen is reduced according to the sub-screen, and then displayed.

As various broadcast technologies have been developed, even when a broadcast screen is based on a broadcast signal received through one broadcast channel, the broadcast screen is comprised of a plurality of regions in which various contents are displayed. For example, a band-shaped screen informing stock information in real-time may be displayed at the bottom of a screen on which a broadcast program is displayed. Even though a user wants to see only information (stock information in the above example), displayed in a partial region of a broadcast screen of another broadcast channel, while seeing a broadcast program of a predetermined broadcast channel, if the user selects the related art PIP mode, the entire screen of another broadcast channel is reduced and displayed in a corresponding sub-screen.

However, the related art system has various problems as disadvantages. For example, but not by way of limitation, in general, the size of the sub-screen is smaller than the size of the main screen, and the size of a partial region (region in which stock information is displayed) which the user wants to see, of the entire screen of another broadcast channel that is reduced and displayed on the sub-screen, is further reduced. Thus, the resolution of the output display is lowered, and corresponding information cannot be easily recognized. In particular, the information of a region, which the user does not want to see, is also displayed on the sub-screen. That is, other information in addition to the stock information is displayed on the sub-screen. Thus, a screen configuration becomes complicated needlessly.

### SUMMARY OF THE INVENTION

The present invention provides a method for processing broadcast signals, which allows only information displayed in a partial region of a broadcast screen of another broadcast channel to be displayed in improved picture quality with a broadcast program of a predetermined broadcast channel, a method for displaying a broadcast screen obtained from the broadcast signals, and an apparatus therefor

The present invention further provides a method for processing broadcast signals, which allows a user to see a broadcast program of a predetermined broadcast channel and simultaneously to see only information which he wants to see, of a broadcast screen of another broadcast channel, a method for displaying a broadcast screen obtained from the broadcast signals, and an apparatus therefor.

According to one aspect of the present invention, there is provided a method for displaying a broadcast screen obtained from broadcast signals. The method includes displaying a PIP screen of which main screen is formed out of a first entire screen that is obtained from a first broadcast channel and of which sub-screen is formed out of a partial screen forming a partial region of a second entire screen that is obtained from a second broadcast channel.

It is preferable that the displaying includes displaying the PIP screen in which the partial screen is a band-shaped screen placed at the bottom of the second entire screen, and displaying the PIP screen in which the partial screen is a stock information screen placed in the second entire screen.

According to another aspect of the present invention, there is provided a method for processing broadcast signals. The method includes (a) obtaining an entire screen signal used to display a first entire screen which corresponds to a first broadcast signal received from a first broadcast channel, (b) obtaining a partial screen signal used to display a partial screen forming part of a second entire screen which corresponds to a second broadcast signal received from a second broadcast channel, and (c) synthesizing the entire screen signal with the partial screen signal and generating a PIP screen signal used to display a PIP screen in which the partial screen signal forms a sub-screen and the first entire screen forms a main screen.

It is preferable that (c) includes extracting a band-shaped screen from the second entire screen as the partial screen, and extracting a stock information screen placed in the second entire screen as the partial screen.

According to another aspect of the present invention, there is provided an apparatus for processing broadcast signals. The apparatus includes a tuning portion which receives a first and a second broadcast signals from a first and a second broadcast channels, a signal processing portion which processes the first broadcast signal and outputs a entire screen signal used to display a first entire screen and processes the second broadcast signal and outputs a partial screen signal used to display a partial screen forming a partial region of a second entire screen, and a screen synthesizing portion which synthesizes the entire screen signal with the partial screen signal and outputs a PIP screen signal used to display a PIP screen in which the partial screen forms a sub-screen and the first entire screen forms a main screen.

It is preferable that the signal processing portion includes a video signal processor which extracts a video signal used to display the first entire screen, from the first broadcast signal and outputs the extracted video signal as the entire screen signal and extracts a video signal used to display the partial screen, from the second broadcast signal and outputs the extracted video signal as the partial screen signal.

It is more preferable that the video signal processor outputs the partial screen signal used to display a stock information screen placed in the second entire screen as the partial screen.

### BRIEF DESCRIPTION OF THE DRAWINGS

The above objects and advantages of the present invention will become more apparent by describing in detail preferred embodiments thereof with reference to the attached drawings in which:

FIG. 1 is a reference view illustrating a related art method for displaying broadcast signals using a picture in picture (PIP) technology;

FIG. 2 illustrates a TV system according to an exemplary, non-limiting embodiment of the present invention;

FIG. 3 illustrates a remote controller as an example of devices for transmitting an user input according to an exemplary, non-limiting embodiment of the present invention;

FIG. 4 is a detailed block diagram of a set-top box according to an exemplary, non-limiting embodiment of the present invention;

FIG. 5 is a detailed block diagram of the set-top box according to another exemplary, non-limiting embodiment of the present invention;

FIG. 6 illustrates the structure of a PIP screen according to an exemplary, non-limiting embodiment of the present invention;

FIG. 7 illustrates the structure of the PIP screen according to another exemplary, non-limiting embodiment of the present invention;

FIG. 8 illustrates the structure of the PIP screen according to another exemplary, non-limiting embodiment of the present invention;

FIG. 9 is a flow chart illustrating a method for displaying a broadcast screen obtained from broadcast signals according to an exemplary, non-limiting embodiment of the present invention;

FIG. 10 is a flow chart illustrating the method for displaying broadcast signals according to another exemplary, non-limiting embodiment of the present invention; and

FIG. 11 illustrates an example of the PIP screen according to an exemplary, non-limiting embodiment of the present invention.

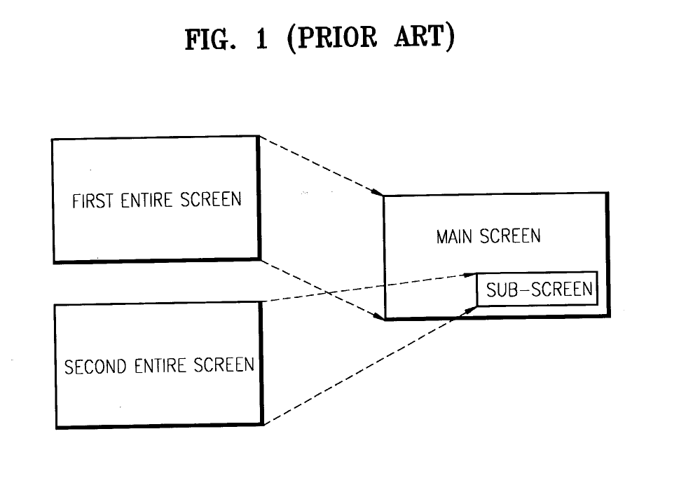

### DETAILED DESCRIPTION OF THE INVENTION

Hereinafter, preferred embodiments of the present invention will be described in detail hereinafter with reference to the accompanying drawings.

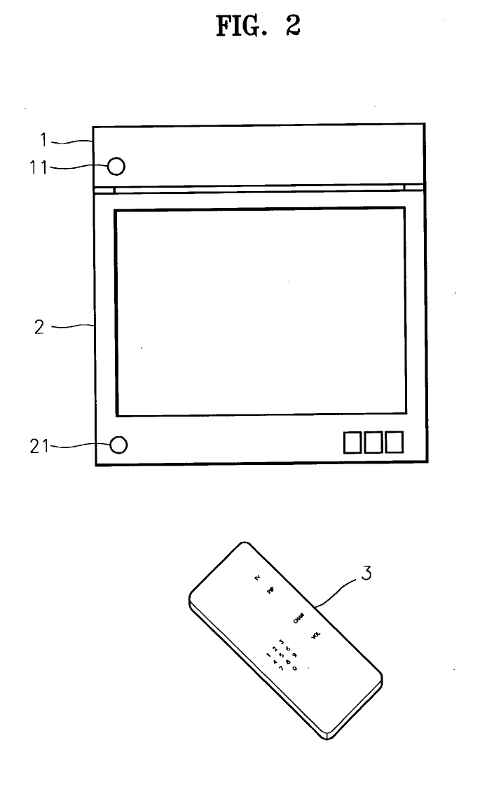

FIG. 2 illustrates a TV system according to an embodiment of the present invention, including a set-top box 1, a TV 2, and a remote controller 3. The set-top box 1 and the TV 2 are devices according to the embodiment of the present invention. The set-top box 1 processes received broadcast signals and outputs the processed broadcast signals to the TV 2, which displays a picture in picture (PIP) screen using signals inputted from the set-top box 1.

A user operates the set-top box 1 or TV 2 by pushing various functional and control buttons provided on the remote controller 3. User input receiving portions 11, 21 which receive user inputs, are provided on the set-top box 1 and the TV 2, respectively. In the present invention, the user input receiving portions 11, 21 are implemented with an infrared ray (IR) receiver and receive infrared ray signals (i.e., user inputs such as user's channel selection information and control commands) from the remote controller 3. However, the present invention is not limited thereto, and alternative signal communication schemes may be used.

The set-top box 1 receives a broadcast signal from a broadcast channel selected by the user and provides the received broadcast signal to the TV 2, which displays a broadcast signal provided by the set-top box 1. In particular, the set-top box 1 processes first and second broadcast signals that are respectively received from two broadcast channels, in the PIP mode according to the present invention and outputs the PIP screen signal used to display the PIP screen to the TV 2, which displays the PIP screen using the PIP screen signal received from the set-top box 1.

Alternatively, the set-top box 1 may be embedded in the TV 2 such that a separate name referred to as a set-top box is not used, and thus all functions that are performed by the set-top box 1 described herein are performed by the TV 2. Further, the user input receiving portion 11 of the set-top box 1 and the user input receiving portion 21 of the TV 2 may be implemented in a single body.

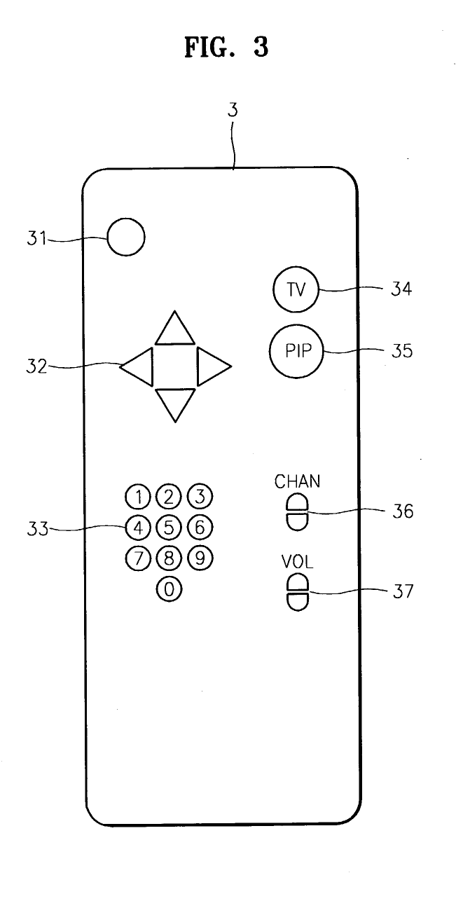

FIG. 3 illustrates a remote controller 3 according to the present invention as an example of devices for transmitting an user input, including an ON/OFF button 31, a four-direction key 32, a number key pad 33, a TV button 34, a PIP button 35, a channel movement key 36, and a volume control key 37. In particular, the four-direction key 32 moves the number of a broadcast channel presently selected upward or downward, and the PIP button 35 selects the PIP mode according to the present invention.

If the user pushes the PIP button 35 and then inputs a number of a broadcast channel which the user wants to see as a sub-screen, or alternatively, the user inputs the number of a desired broadcast channel and then pushes the PIP button 35, a partial screen that is preset for a corresponding broadcast channel is displayed as the sub-screen. Only a method for selecting the PIP mode and a method for selecting a broadcast channel to be displayed as the sub-screen may be implemented in another manner. Further, at least part of various functional buttons provided to the remote controller 3 may be implemented with a menu screen having an on screen display (OSD).

An infrared ray generator (not shown) is embedded in the remote controller 3. If various buttons or keys of the infrared ray generator representing a control or function are selected, a corresponding infrared ray signal is generated and transmitted to the user input receiving portion 11, 21 of the respective set-top box 1 or TV 2.

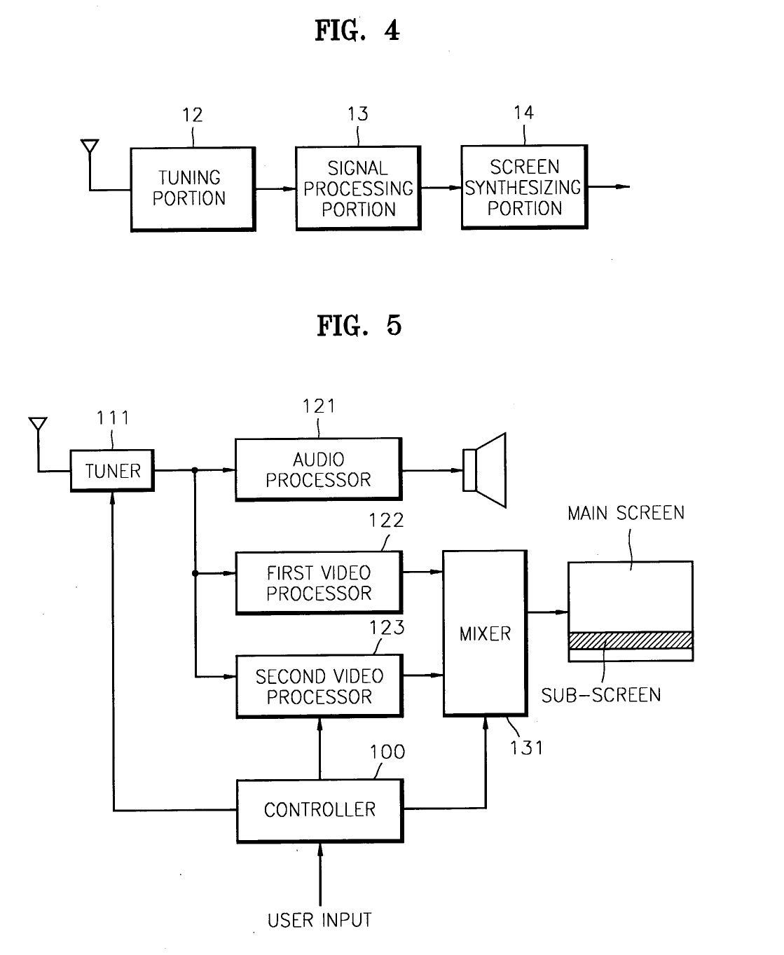

FIG. 4 is a detailed block diagram of the set-top box 1, including a tuning portion 12, a signal processing portion 13, and a screen synthesizing portion 14. The tuning portion 12 receives first and second broadcast signals from each of two broadcast channels of external broadcasting sources in the PIP mode. The signal processing portion 13 processes the first broadcast signal received by the tuning portion 12, and outputs a signal (i.e., partial screen signal) used to display a partial screen forming part of a corresponding entire screen. Also, the signal processing portion 13 processes a second broadcast signal received by the tuning portion 12, and outputs a signal (i.e., entire screen signal) used to display the corresponding entire screen.

The screen synthesizing portion 14 synthesizes a signal outputted by the signal processing portion 13, and outputs a signal used to display the PIP screen of which the partial screen is formed of a sub-screen and of which the entire screen is formed of a main screen, to the TV 2. This signal is referred to as a PIP screen signal.

‘Entire screen’ represents a broadcast screen corresponding to a broadcast signal received from a predetermined broadcast channel and is so referenced because a screen covers the entire screen are of the TV 2. ‘Partial screen’ represents a partial region of the entire screen. For example, but not by way of limitation, the partial screen includes only a screen on which continuous, real-time information, such as stock information is displayed when a predetermined broadcast program is displayed as the entire screen on a predetermined broadcast screen, and the stock information overlaps in the partial region of the entire screen. ‘PIP screen’ is a screen displaying broadcast signals according to the present invention and is formed of a ‘main screen’ and a ‘sub-screen’. ‘Main screen’ represents a broadcast screen generally displayed on the PIP screen, and ‘Sub-screen’ represents a broadcast screen embedded in the main screen or arranged in a row with the main screen and displayed additionally.

FIG. 5 is a detailed block diagram of the set-top box 1 according to another embodiment of the present invention, including a tuner 111, an audio processor 121, a first video processor 122, a second video processor 123, a controller 100, and a mixer 131. The controller 100 receives a user input through the remote controller 3 and outputs a corresponding control command to the tuner 111, the second video processor 123, and/or the mixer 131. More specifically, the tuner 111 transmits broadcast information informing a broadcast channel of a broadcast signal to be received, the second video processor 123 instructs to process a corresponding broadcast signal so as to obtain a partial screen that is preset when the user selects the PIP mode according to the present invention, and the mixer 131 instructs to synthesize the PIP screen according to the present invention. For this purpose, information required to obtain the partial screen is preset in the controller 100. For example, but not by way of limitation, if the user selects the PIP mode and inputs a desired broadcast channel as the partial screen, the controller 100 controls the tuner 111, the second video processor 123, and the mixer 131 so that the partial screen is displayed as preset.

The tuner 111 receives broadcast signals from each of two broadcast signals according to channel information provided by the controller 100 and outputs the received broadcast signals, respectively. The first video processor 122 extracts a corresponding video signal from the first broadcast signal received by the tuner 111, processes the extracted video signal and outputs an entire screen signal used to display the entire screen. The second video processor 123 extracts a corresponding video signal from the second broadcast signal received by the tuner 111, processes the extracted video signal and outputs a partial screen signal used to display the partial screen. In the present embodiment, the second video processor 122 extracts the corresponding video signal from the second broadcast signal so that for example, but not by way of limitation a stock information screen representing real-time, continuous information placed in a second entire screen according to the second broadcast signal is displayed as the partial screen.

The audio processor 121 extracts and processes an audio signal that corresponds to the entire screen or to the partial screen. The mixer 131 synthesizes the entire screen signal with the partial screen signal and outputs a PIP screen signal used to display the PIP screen of which the main screen is formed from an output of the entire screen obtained from the first broadcast channel and of which the sub-screen is formed from the partial screen obtained from the second broadcast channel.

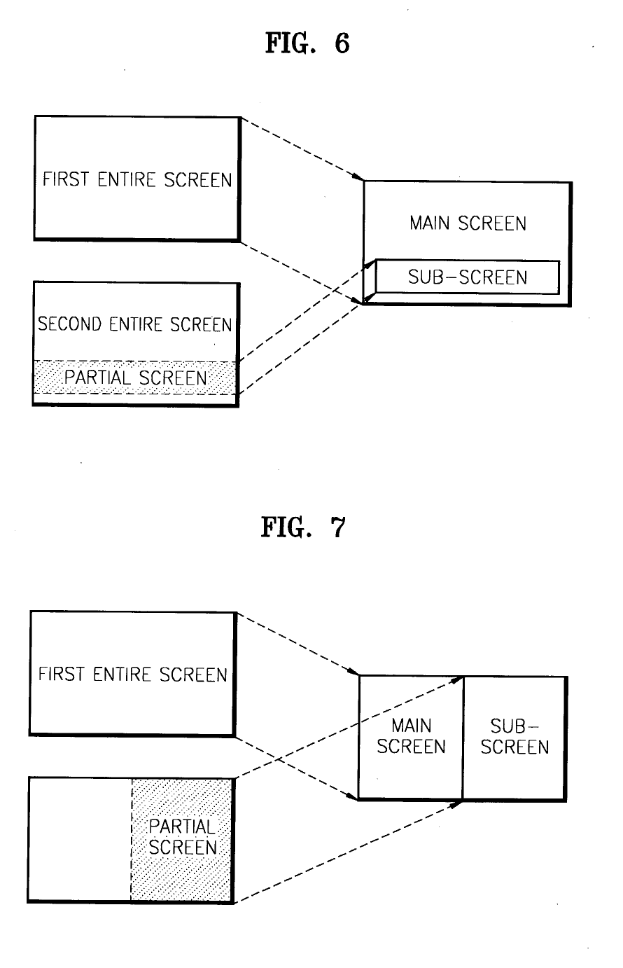

FIG. 6 illustrates the structure of a PIP screen according to an exemplary, non-limiting embodiment of the present invention. The first entire screen obtained from the first broadcast signal is displayed as the main screen, and a partial screen that is selected from the second entire screen obtained from the second broadcast signal is displayed as the sub-screen. That is, the first video processor 122 extracts a video signal which corresponds to the first entire screen, from the first broadcast signal and outputs the entire screen signal. The second video processor 123 extracts a video signal which corresponds to the partial screen displayed in gray, from the second broadcast signal and outputs the partial screen signal. The mixer 131 mixes the entire screen signal with the partial screen signal and outputs the PIP screen signal used to display the PIP screen. In the present invention, the sub-screen of the PIP screen is a band-shaped partial screen provided at the bottom of the second entire screen.

FIG. 7 illustrates the structure of the PIP screen according to another embodiment of the present invention. The first entire screen obtained from the first broadcast signal is displayed as the main screen, and a partial screen that is selected from the second entire screen obtained from the second broadcast signal is displayed as the sub-screen. Similarly, the first video processor 122 extracts a video signal that corresponds to the first entire screen from the first broadcast signal and outputs the entire screen signal.

The second video processor 123 extracts a video signal that corresponds to the partial screen displayed in gray from the second broadcast signal and outputs the partial screen signal. The mixer 131 mixes the entire screen signal with the partial screen signal and outputs the PIP screen signal used to display the PIP screen comprised of the corresponding main screen and sub-screen. In this embodiment of the present invention, the sub-screen of the PIP screen is a partial screen, which takes the right half of the second entire screen.

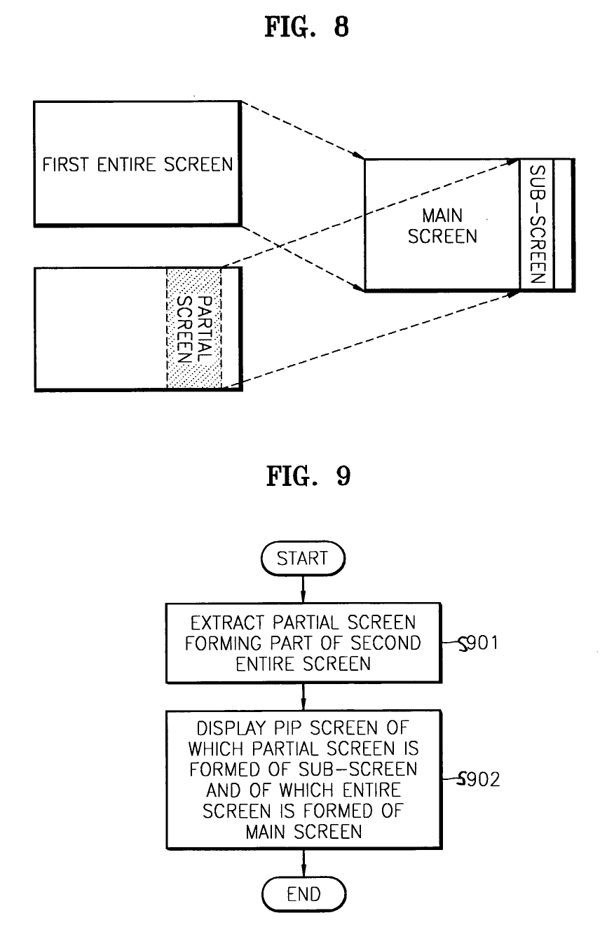

FIG. 8 illustrates the structure of the PIP screen according to another exemplary, non-limiting embodiment of the present invention. The first entire screen obtained from the first broadcast signal is displayed as the main screen, and a partial screen selected from the second entire screen obtained from the second broadcast signal is displayed as the sub-screen. Similarly, the first video processor 122 extracts a video signal which corresponds to the first entire screen from the first broadcast signal and outputs the entire screen signal. The second video processor 123 extracts a video signal which corresponds to the partial screen displayed in gray from the second broadcast signal and outputs the partial screen signal. The mixer 131 mixes the entire screen signal with the partial screen signal and outputs the PIP screen signal used to display the PIP screen comprised of corresponding main screen and sub-screen. In the present invention, the sub-screen of the PIP screen is a pillar-shaped partial screen placed at right side of the second entire screen.

The partial screen forms part of the entire screen, and may be extracted in various shapes. Also, in the present embodiments, the sub-screen corresponds to 100% magnifications of the extracted partial screen, but the partial screen may be reduced or magnified and displayed as necessary. Even though the partial screen may be reduced or magnified and displayed, the partial screen in the PIP mode according to the present invention is different from the related art PIP mode because the entire screen is reduced according to the allotted sub-screen in the related art PIP mode, but in the PIP mode according to the present invention, the partial screen of the entire screen is extracted and then displayed, magnified or reduced.

A method for displaying a broadcast screen obtained from broadcast signals according to preferred embodiments of the present invention based on the above novel structure is described below.

FIG. 9 is a flow chart illustrating a method for displaying a broadcast screen obtained from broadcast signals according to an in the PIP mode according to the present invention embodiment of the present invention. A TV system receives the first broadcast signal from the first broadcast channel, extracts a video signal used to display the first entire screen from the received first broadcast signal, and generates the corresponding entire screen signal. In step S901, the TV system receives the second broadcast signal from the second broadcast channel, extracts a video signal used to display a partial screen forming part of the second entire screen from the received second broadcast signal, and generates a corresponding partial screen signal. In step S902, the TV system synthesizes the generated entire screen signal with the generated partial screen signal, and displays a PIP screen of which the partial screen is formed of a sub-screen and the entire screen is formed of a main screen.

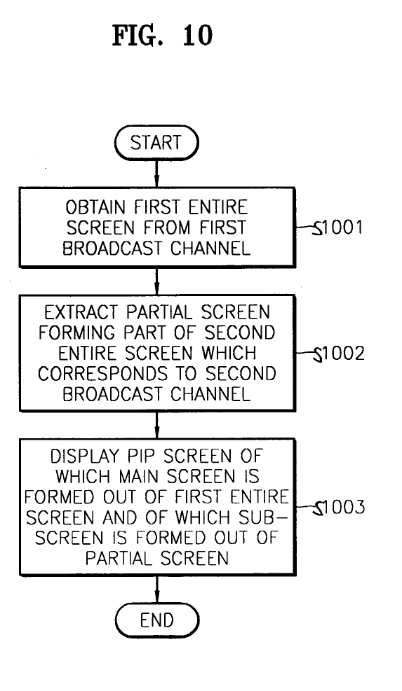

FIG. 10 is a flow chart illustrating the method for displaying broadcast signals according to another embodiment of the present invention. In step S1001, the TV system receives the first broadcast signal from the first broadcast channel, extracts a video signal used to obtain the first entire screen from the received first broadcast signal, and processes the extracted video signal. In step S1002, the TV system receives the second broadcast signal from the second broadcast channel, extracts a video signal used to display the partial screen forming part of the second entire screen which corresponds to the received second broadcast signal, and processes the extracted video signal. A band-shaped screen placed at the bottom of the first entire screen may be extracted as the partial screen. Preferably, a continuous, real-time (e.g., stock) information screen placed in the first entire screen is extracted as the partial screen. In step S1003, the signals obtained in steps S1001 and S1002, are synthesized with each other, and a PIP screen, of which the main screen is formed from the first entire screen and of which sub-screen is formed from the partial screen, is displayed.

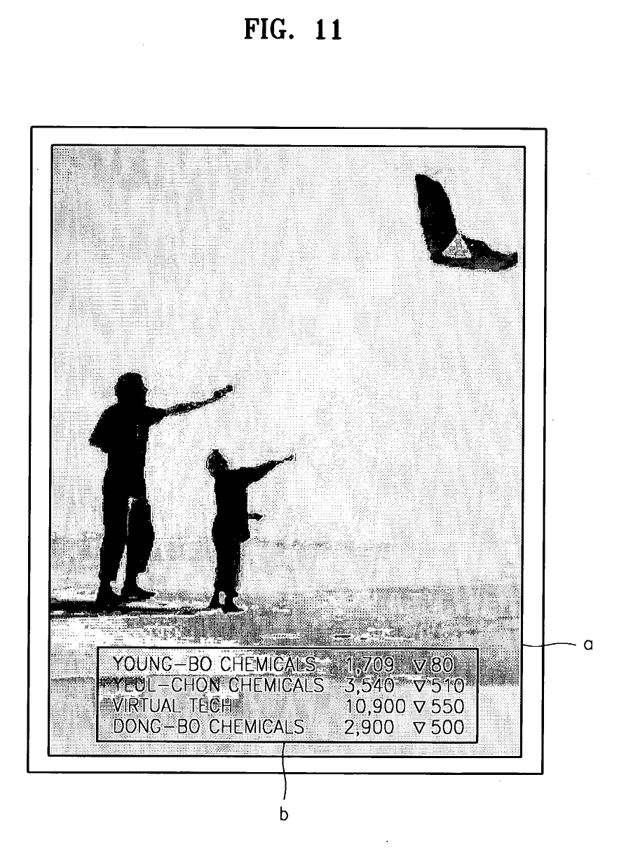

FIG. 11 illustrates an example of the PIP screen according to an exemplary, non-limiting embodiment of the present invention. Reference numeral a denotes a main screen which represents the entire screen corresponding to the first broadcast signal, and reference numeral b denotes a sub-screen which represents e.g., a stock information screen, which is the partial screen corresponding to the second broadcast signal.

The present invention has various advantages. For example, but not by way of limitation, as described above, according to the present invention, information displayed in a partial region of a broadcast screen of another broadcast channel can be displayed in improved picture quality with a broadcast program of a predetermined broadcast channel. That is, unlike the related art PIP mode, information displayed on a sub-screen can be displayed at the same resolution as that of the entire screen in the PIP mode according to the present invention. Thus, a user can see a broadcast program of a predetermined broadcast channel and simultaneously see only information that he or she wants to see, of a broadcast screen of another broadcast channel in improved picture quality.

While this invention has been particularly shown and described with reference to preferred embodiments thereof, it will be understood by those skilled in the art that various changes in form and details may be made therein without departing from the spirit and scope of the invention as defined by the appended claims and equivalents thereof.

What is claimed is:

1. A method for displaying a broadcast screen obtained from broadcast signals, comprising:
displaying a picture-in-picture (PIP) screen, of which a main screen is formed from a first entire screen obtained from a first broadcast channel, and a sub-screen is formed from a partial screen, wherein said partial screen includes only a partial region of a second entire screen obtained from a second broadcast channel.

2. The method of claim 1, wherein said displaying comprises displaying the PIP screen, such that the partial screen is a band-shaped screen located at a bottom portion of the second entire screen.

3. The method of claim 1, wherein said displaying comprises displaying the PIP screen, such that the partial screen is a continuous, real-time information screen placed in the second entire screen.

4. A method for processing broadcast signals, comprising:
(a) obtaining an entire screen signal to display a first entire screen corresponding to a first broadcast signal received from a first broadcast channel;
(b) obtaining a partial screen signal to display a partial screen forming only a part of a second entire screen corresponding to a second broadcast signal received from a second broadcast channel; and
(c) synthesizing the entire screen signal with the partial screen signal and generating a PIP screen signal used to display a PIP screen in which the partial screen signal forms a sub-screen and the first entire screen forms a main screen.

5. The method of claim 4, wherein said (c) comprises extracting a band-shaped screen from the second entire screen as the partial screen.

6. The method of claim 4, wherein said (c) further comprises extracting a continuous, real-time information screen located in the second entire screen as the partial screen.

7. An apparatus for processing broadcast signals, comprising:
a tuning portion that receives a first broadcast signal and a second broadcast signal from a first broadcast channel and a second broadcast channel, respectively;
a signal processing portion that processes the first broadcast signal and outputs an entire screen signal to display a first entire screen, and processes the second broadcast signal and outputs a partial screen signal used to display a partial screen forming only a partial region of a second entire screen; and
a screen synthesizing portion that synthesizes the entire screen signal with the partial screen signal, and outputs a PIP screen signal to display a PIP screen in which the partial screen forms a sub-screen and the first entire screen forms a main screen.

8. The apparatus of claim 7, wherein the signal processing portion comprises a video signal processor that extracts a video signal used to display the first entire screen from the first broadcast signal, and outputs the extracted video signal as the entire screen signal and extracts a video signal used to display the partial screen from the second broadcast signal, and outputs the extracted video signal as the partial screen signal.

9. The apparatus of claim 8, wherein the signal processing portion further comprises an audio signal processor that extracts an audio signal transmitted with the entire screen from the first broadcast signal, and outputs the extracted audio signal.

10. The apparatus of claim 8, wherein the video signal processor outputs the partial screen signal used to display continuous, real-time information screen placed in the second entire screen as the partial screen.

11. The apparatus of claim 10, wherein said continuous, real-time information is stock information.

12. The method of claim 6, wherein said continuous, real-time information is stock information.

13. The method of claim 3, wherein said continuous, real-time information is stock information.
